(19) United States
(12) Patent Application Publication
(10) Pub. No.: US 2020/0329388 A1
(43) Pub. Date: Oct. 15, 2020

(54) Miracast Framework Enhancements For Direct Streaming Mode

(71) Applicant: QUALCOMM Incorporated, San Diego, CA (US)

(72) Inventor: Tony Gogoi, San Diego, CA (US)

(21) Appl. No.: 16/593,338

(22) Filed: Oct. 4, 2019

Related U.S. Application Data
(60) Provisional application No. 62/833,651, filed on Apr. 13, 2019.

(51) Int. Cl. H04W 24/08; H04L 12/18; H04L 29/06; H04L 12/26; H04L 29/08; H04W 84/12

(52) U.S. Cl. CPC H04W 24/08; H04L 12/189; H04L 65/4076; H04W 84/12; H04L 65/80; H04L 43/0829; H04L 67/16; H04L 65/60

(57) ABSTRACT

Various embodiments include methods, systems, and devices for streaming a compressed media stream between a source computing device and a sink computing device. In some embodiments, the source computing device and the sink computing device may be operating in Wi-Fi Miracast® direct mode. Various embodiments may enable a sink computing device to indicate a pre-transmitted data maximum buffer size and/or an indication of an access unit drop capability to a source computing device. Various embodiments may provide a priority-based transmission scheme for use by a source computing device sending access unit meta data of a compressed media stream, such as presentation time stamps, render statuses, etc., to a sink computing device. Various embodiments may enable a sink computing device to drop access units that were dropped by a source computing device.

### RELATED APPLICATIONS

This application claims the benefit of priority to U.S. Provisional Application No. 62/833,651, entitled “Miracast Framework Enhancements For Direct Streaming Mode” filed Apr. 13, 2019, the entire contents of which are hereby incorporated herein by reference for all purposes.

### BACKGROUND

Miracast is a technology that allows users to wirelessly share multimedia, including high-resolution pictures and high-definition (HD) video content between Wi-Fi devices.

### SUMMARY

Various aspects of the present disclosure include methods, systems, and devices for streaming a compressed media stream between a source computing device and a sink computing device. In some aspects, the source computing device and the sink computing device may be operating in Wi-Fi Miracast® direct streaming mode. Various aspects may enable a sink computing device to indicate a pre-transmitted data maximum buffer size and/or an indication of an access unit drop capability to a source computing device. Various aspects may provide a priority-based transmission scheme for use by a source computing device sending unit meta data of a compressed media stream, such as render statuses, etc., to a sink computing device. Various aspects may enable a sink computing device to drop access units that were dropped by a source computing device.

Various aspects include methods of rendering a compressed media stream by a sink computing device that may include receiving a presentation packet from a source computing device in which the presentation packet indicates a render status and a presentation time stamp assigned by the source computing device to an access unit of a media stream, determining whether the render status indicates the access unit was rendered by the source computing device, dropping the access unit in response to determining that the render status indicates the access unit was not rendered by the source computing device, and rendering the access unit in response to determining that the render status indicates the access unit was rendered by the source computing device.

Some aspects may further include receiving a get message from the source computing device, the get message requesting parameters from the sink computing device, and sending an indication of access unit drop capability to the source computing device in response to receiving the get message.

Various aspects include methods of streaming a compressed media stream by a source computing device that may include determining a presentation time stamp for a compressed access unit of a media stream, determining a render status for the compressed access unit, generating a presentation packet indicating the render status and the presentation time stamp, and sending the presentation packet to a sink computing device.

In some aspects, the media stream may be a video stream or an audio stream.

In some aspects, the source computing device and the sink computing device may be operating in Wi-Fi Miracast® direct mode.

Further aspects include a computing device including a processor configured with processor-executable instructions for performing operations of any of the methods described herein. Further aspects include a non-transitory processor-readable medium on which is stored processor-executable instructions configured to cause a computing device to perform operations of any of the methods described herein. Further aspects include a computing device including means to perform operations of any of the methods described herein.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A is a system block diagram of a wireless media delivery platform or system suitable for use with various embodiments.

FIG. 1B is a component block diagram illustrating example components of a source computing device and a sink computing device suitable for use with various embodiments.

FIG. 2 is a process flow diagram illustrating a method for establishing direct streaming between a source computing device and a sink computing device according to some embodiments.

FIG. 3 is a process flow diagram illustrating a method for streaming a compressed media stream according to some embodiments.

FIG. 4 is a process flow diagram illustrating a method for streaming a compressed media stream according to some embodiments.

FIG. 5 is a process flow diagram illustrating a method for streaming a compressed media stream according to some embodiments.

FIG. 6A is a process flow diagram illustrating a method for streaming a compressed media stream according to some embodiments.

FIG. 6B is a process flow diagram illustrating a method for streaming a compressed media stream according to some embodiments.

FIG. 7A is a process flow diagram illustrating a method for streaming a compressed media stream according to some embodiments.

FIG. 7B is a process flow diagram illustrating a method for streaming a compressed media stream according to some embodiments.

FIG. 8 is a process flow diagram illustrating a method for sending a transport packet to a sink computing device according to some embodiments.

FIG. 9 is a process flow diagram illustrating a method for sending a presentation packet to a sink computing device according to some embodiments.

FIG. 10 is a process flow diagram illustrating a method for streaming a compressed media stream according to some embodiments.

FIG. 11A is a process flow diagram illustrating a method for streaming a compressed media stream according to some embodiments.

FIG. 11B is a process flow diagram illustrating a method for streaming a compressed media stream according to some embodiments.

FIG. 12 is a component block diagram illustrating an example computing device suitable for use with various embodiments.

FIG. 13 is a component block diagram illustrating an example computing device suitable for use with various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the disclosure or the claims. Alternate embodiments may be devised without departing from the scope of the disclosure. Additionally, well-known elements of the disclosure will not be described in detail or will be omitted so as not to obscure the relevant details of the disclosure.

As used herein, the term “computing device” refers to an electronic device equipped with at least a processor. Computing devices may include wireless communication devices (e.g., cellular telephones, wearable devices, smart-phones, web-pads, tablet computers, Internet enabled cellular telephones, Wi-Fi® enabled electronic devices, personal data assistants (PDAs), laptop computers, etc.), personal computers, display units, smart televisions, servers, etc. In various embodiments, computing devices may be configured with memory and/or storage. Additionally, computing devices referred to in various example embodiments may be coupled to or include wireless communication capabilities implementing various embodiments, such as network transceiver(s) and antenna(s) configured to establish a local area network (LAN) connection (e.g., Wi-Fi® transceivers).

As used herein, the term “access unit” refers to a coded representation of a unit of media that may be rendered, such as an audio frame, video frame, etc. Access units for video may include various types of video frames, such as I-frames, P-frames, etc. As used herein, the term “compressed access unit” refers to an access unit that is in an encoded state prior to decoding by a media player to make the access unit renderable, such as prior to a media player performing audio-visual synchronization (AV sync) operations and frame rendering operations. Compressed access units may be received at a media player from external sources (e.g., video-on-demand services, over-the-top services, etc.) and/or from local multimedia files stored on a computing device.

In various embodiments, computing devices in a wireless network, such as Wi-Fi Miracast® network, may be categorized as sources and/or sinks depending upon whether the devices are transmitting or receiving content data. Sources or source devices are computing devices that send access units (e.g., content frames, content packets, etc.) to one or more other computing devices (i.e., sink devices).

For example, source devices may operate as a server providing frames or packets to other computing devices in the wireless network. Sinks or sink devices are computing devices that receive access units (e.g., content frames, content packets, etc.) from one or more other computing devices. Computing devices may exclusively operate as sources, exclusively operate as sinks, or operate as both a sink and a source in a wireless network, such as a Wi-Fi Miracast® network. As an example, a Wi-Fi Miracast® network may include a smartphone acting as a source wirelessly projecting streaming Moving Picture Experts Group (MPEG) format imagery onto one or more nearby connected display units acting as one or more sinks.

Various examples of different wireless connections, wireless networks, and wireless media delivery platforms, are discussed herein, specifically Wi-Fi Miracast® connections, networks, and media delivery platforms. The discussions of Wi-Fi Miracast® are provided merely as examples to better illustrate the aspects of the various embodiments, and are not intended to limit the claims to Wi-Fi Miracast® unless specifically recited. Other wireless connections, wireless networks, and wireless media delivery platforms (e.g., Apple AirPlay®, Wi-Di, etc.) may use or be used with the various embodiments, and other wireless connections, wireless networks, and wireless media delivery platforms may be substituted in the various examples discussed herein.

Wireless media delivery platforms (e.g., Wi-Fi Miracast®, Apple AirPlay®, Wi-Di, etc.) may wirelessly mimic high definition multimedia interface (HDMI) media streams using Moving Picture Experts Group (MPEG) transport streams. For example, a user may push a button on a smartphone to wirelessly project streaming MPEG format data (e.g., MPEG format imagery, MPEG format audio, text, etc.) onto one or more nearby connected display units and/or speakers. The wireless projection of streaming media streams from a source computing device to a sink computing device may be referred to as screen mirroring. In screen mirroring, end-to-end latency may be critical. End-to-end latency may be defined as the amount of delay between a frame being rendered on the source computing device and the time when that same frame is presented at the sink computing device.

Screen mirroring may occur in various different modes of operation, such as normal modes, direct streaming modes, etc. One example of a screen mirroring mode is the direct-streaming mode in Wi-Fi Miracast®. Direct streaming mode in Wi-Fi Miracast® facilitates compressed multimedia streams to be sent directly from a source computing device to a sink computing device, while other display layers (e.g., a progress-bar, menu overlay, etc.) may be transmitted separately as an overlay. In direct streaming mode in Wi-Fi Miracast® the source computing device may have no control over the encode parameters of the video stream. Such streams may or may not be tuned for low latency. For example, a stream that is latency critical may be tuned for low latency, whereas a movie may be tuned for high quality at the expense of latency. A typical direct streaming use-case is a clip (streamed or local) played by a media player. The compressed video stream can be transmitted directly to the sink computing device from the source computing device in direct streaming mode. In this manner, direct streaming mode in Wi-Fi Miracast® provides for streaming compressed content directly to the sink computing device, thereby bypassing the step of encoding frames from the display unit. The transmission of compressed content itself may allow the quality of a compressed stream to be preserved during transmission to the sink computing device.

Various embodiments include methods, systems, and devices for streaming a compressed media stream between a source computing device and a sink computing device. In some embodiments, the source computing device and the sink computing device may be operating in Wi-Fi Miracast® direct mode. Various embodiments may enable direct streaming that may achieve low latency. Various embodiments may achieve sufficient quality streaming in the face of high transient bitrates and/or network bandwidth fluctuations. Various embodiments may enable a sink computing device to receive access units, such as video access units, in decode-order instead of presentation-order. Various embodiments may alleviate the problem of network jitter, as access unit data, such as video access unit data, may be sent ahead of presentation time. Various embodiments may enable low latency delivery of both non-latency critical applications (e.g., movie direct streaming, etc.) and latency critical applications (e.g., live game direct streaming, betting direct streaming, etc.). Various embodiments may enable a user input back channel feature to be provided in Wi-Fi Miracast® direct mode because source and sink computing devices may be rendering the same access units. Various embodiments may reduce the instantaneous build-up of video frames for transmission from source computing devices to sink computing devices resulting from high transient bitrates in combination with network bandwidth fluctuations, thereby reducing artifacts associated with switching out of Wi-Fi Miracast® direct mode because of the instantaneous build-up of video frames.

Various embodiments may enable source computing devices and sink computing device to negotiate capabilities to support streaming a compressed media stream. Various embodiments may enable a sink computing device to indicate a pre-transmitted data maximum buffer size and/or an indication of an access unit drop capability to a source computing device.

In some embodiments, a sink computing device may send an indication of a pre-transmitted data maximum buffer size in a reply message to a source computing device. In some embodiments, the pre-transmitted data maximum buffer size may be the maximum amount of pre-transmitted video-data for which the corresponding keyed-Packetized Elementary Stream (keyed-PES) packet has not yet been transmitted that the sink computing device may store. As used herein, a keyed-PES packet may be an MPEG-2 Packetized Elementary Stream (PES) packet in which access unit data is not carried. Rather, a keyed-PES packet may carry at least a key identifier enabling the access unit data associated with that key identifier to be determined. This pre-transmitted data maximum buffer size may be independent of any private pre-roll on the sink computing device side. The pre-transmitted data maximum buffer size may represent a contract of the amount of pre-transmitted data that must be accepted by the sink computing device without pausing socket reads or discarding earlier pre-transmitted access units. The provisioning of the pre-transmitted data maximum buffer size may indicate the capability of the sink computing device to accept pre-transmitted video access-units on MPEG-2 transport stream (MPEG-2 ts) private stream 2, cache those pre-transmitted video access-units on receipt, and later render those transmitted video access-units when the corresponding keyed-PES packet for the pre-transmitted access-units is received.

In some embodiments, a sink computing device may send an indication of an access unit drop capability in a reply message to a source computing device. An access unit drop capability may indicate the sink computing device's ability to decode and then either render or drop decoded access units based on indications, such as a render-action indication, carried in the data field of a keyed-PES packets or in another presentation packet received from a source computing device.

In some embodiments, an indication of a pre-transmitted data maximum buffer size and an indication of an access unit drop capability to a source computing device may be indicated in the same reply message sent by the sink computing device. As one example, the indication of a pre-transmitted data maximum buffer size and the indication of an access unit drop capability to a source computing device may each be separate elements in a Real Time Streaming Protocol (RTSP) reply message. As another example, a single element in an RTSP reply message may indicate both an indication that the sink computing device has access unit drop capability and an indication of a pre-transmitted data maximum buffer size. Specifically, the presence of a pre-transmit-data capability element in an RTSP reply message may serve as an indication that the sink computing device has access unit drop capability and the value of the pre-transmit-data capability element may be the indication of the pre-transmitted data maximum buffer size.

Various embodiments may provide a priority-based transmission scheme for use by a source computing device sending access unit metadata of a compressed media stream, such as presentation time stamps, render statuses, etc., to a sink computing device. In some embodiments, a priority-based transmission scheme may include only sending pre-transmit access-units ahead of a presentation time stamp of a last presentation sent at full or reduced bandwidth. In some embodiments, the source computing device may assign unique key identifiers to compressed access units to be transmitted to a sink computing device. The compressed access units may be received sometime before the media player of the source computing device decodes the compressed access unit into a renderable access unit. Compressed access units for transport to a sink computing device may be received by a transport component (e.g., Wi-Fi Miracast® component, Apple AirPlay® component, Wi-Di component, etc.) of the source computing device from a media player of the source computing device. As each compressed access unit is received from the media player at the source, the transport component may assign a unique key identifier to the compressed access unit. The assigned unique key identifier may be included or indicated in a transport packet for the compressed access unit. For example, the transport component may transport packet that includes the compressed access unit and that indicates the assigned key identifier. The transport component may send transport packet to the sink computing device and the sink computing device may store the compressed access unit and its associated unique key in a cache. In some embodiments, the transport component may send transport packet to the sink computing device via MPEG-2 is private stream 2. As the transport packets may be generated by the source computing device before the media player of the source computing device decodes and renders the compressed access units carried in the transport packets into renderable access units, the compressed access units carried in the transport packets may represent pre-transmitted access units.

In some embodiments, whenever a compressed access unit is decoded by the media player and the resulting access unit is processed by the audio-visual (AV) synch operations of the media player, the media player may notify the transport component (e.g., Wi-Fi Miracast® component, Apple AirPlay® component, Wi-Di component, etc.) of the source computing device. The transport component (e.g., Wi-Fi Miracast® component, Apple AirPlay® component, Wi-Di component, etc.) may determine timing information for the access unit, e.g., the presentation time stamp, decoding time stamp, etc., and generate a presentation packet. Rather than including any access unit data, the presentation packet may include the key identifier of the compressed access unit from which the access unit was decoded. The presentation packet may be a keyed-PES packet. In some embodiments, the presentation packet may indicate the key identifier and the presentation time stamp for the compressed access unit. In some embodiments, the presentation packet may further indicate the render status of the compressed access unit. The render status may be an indication of whether the media player rendered the access unit decoded from the compressed access unit or dropped the access unit decoded from the compressed access unit. Access units may be dropped by source computing devices for various reasons, including pausing occurring, fast forwarding occurring, rewinding occurring, or any other reason. In some embodiments, the presentation packet may be a keyed-PES packet including the key identifier of the compressed access unit and the render status substituted for any access unit data in the MPEG-2 PES packet. The presentation packet may be sent from the source computing device to the sink computing device. In some embodiments, a first presentation packet may indicate the key identifier and the presentation time stamp for the compressed access unit and a second presentation packet may indicate the key identifier and the render status of the compressed access unit. The second presentation packet may be sent in response to determining a sink computing device is capable of dropping decoded access units based on render status indications from the source computing device. The second presentation packet may not be sent in response to determining a sink computing device is not capable of dropping decoded access units based on render status indications from the source computing device. The first presentation packet may be sent via a first transport stream and the second presentation packet may be sent via a different transport stream (e.g., via a MPEG-2 is private stream 2).

In some embodiments, in response to receiving a presentation packet, a sink computing device may retrieve a compressed access unit from a cache based at least in part on the key identifier indicated in the presentation packet. The sink computing device may send the compressed access unit and the presentation time stamp to the media player of the sink computing device for decoding and rendering. For example, the transport component (e.g., Wi-Fi Miracast® component, Apple AirPlay® component, Wi-Di component, etc.) of the sink computing device may send the compressed access unit and presentation time stamp to a media player (e.g., an AV sync component of the media player, etc.) of the sink computing device. For example, the media player of the sink computing device may process the compressed access unit as part of its media processing operations to decode and render or drop the access unit. Decoding all access units at the sink computing device may enable information from all access units to be used by the sink computing device, which may prevent decode failures that may be the result of a compressed access unit not being decoded. For example, a B-frame may be dependent on an I-frame and P-frames transmitted ahead of the B-frame in separate compressed access units. If the compressed access units of those I-frames and P-frames are dropped before being decoded, the B-frame could not be decoded properly.

In some embodiments, the sink computing device may drop the decoded access unit without sending the decoded access unit for rendering in response to determining that the render status indicates the access unit was dropped by the sending source computing device. The presentation on the source computing device may be controlled by AV sync operations in the media player. A typical player tends to drop frames from rendering due to various reasons, such as around startup, after a seek operation, etc., due to underlying limitations, such as a frame decode taking longer at startup versus audio streams that have started to play out. This causes undesirable artifacts at startup and following seek on the sink computing device when video frames that were dropped during AV sync operations at the source computing device are rendered at a fast pace in the sink computing device. This over speed rendering may cause jerkiness and momentary fast-forwards during the artifacts during rendering by the sink computing device. The capability to decode and then drop decoded access units at the sink computing device that were not rendered by the source computing device may ensure that the playout by the source computing device matches the playout by the sink computing device, thereby avoiding such artifacts.

In some embodiments, a sink computing device may be capable of dropping decoded access units based on render status indications from the source computing device but may not be capable of receiving pre-transmitted data, such as compressed access units transmitted by the source computing device prior to decoding by the source computing device. In such embodiments, a source computing device may send a presentation packet indicating the presentation time stamp and the render status to the sink computing device. The presentation time stamp may identify the compressed access unit similar to the key identifier discussed herein. In this mariner, the presentation time may also identify the access unit decoded from the compressed access unit by the source computing device as that decoded access unit will have the same presentation time stamp. The presentation packet may be a packet including the presentation time stamp of the compressed access unit and the render status. The presentation packet may be sent from the source computing device to the sink computing device. For example, the presentation packet indicating the presentation time stamp and the render status may be sent via a MPEG-2 is private stream 2. The sink computing device capable of dropping decoded access units based on render status indications from the source computing device while not being capable of receiving pre-transmitted data may determine whether the render status indicates the access unit was rendered by the computing device. In some embodiments, the sink computing device may drop the decoded access unit without sending the decoded access unit for rendering in response to determining that the render status indicates the access unit was dropped by the sending source computing device.

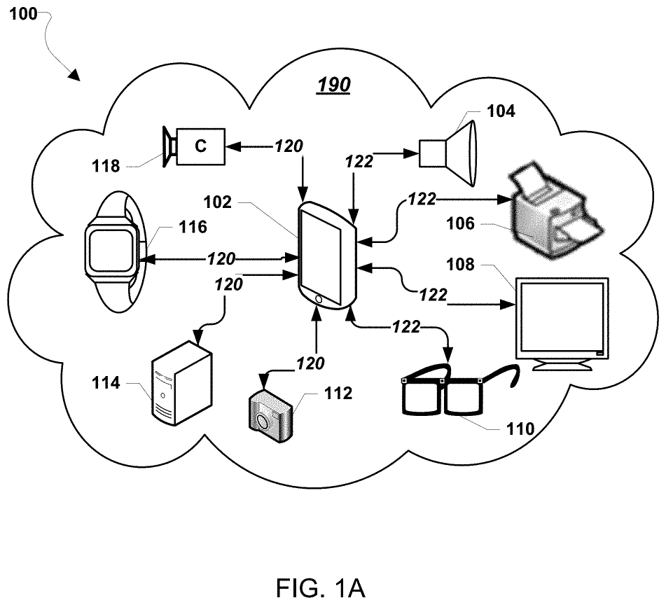

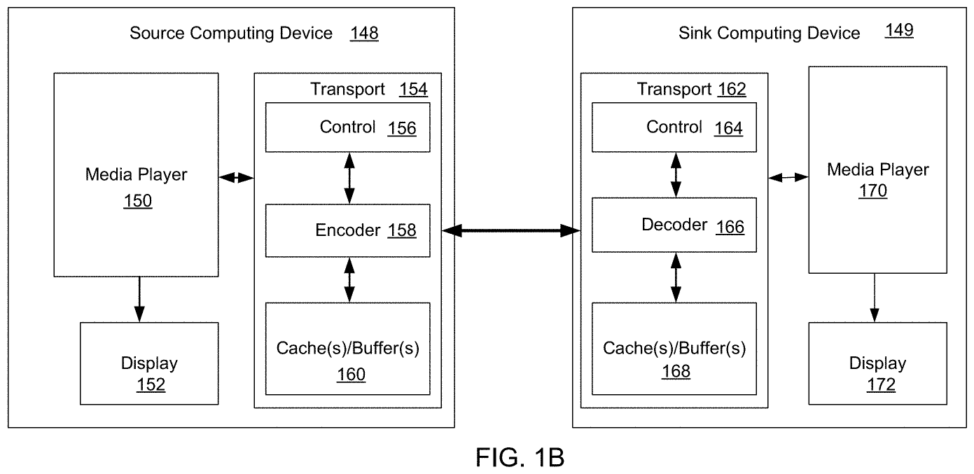

FIG. 1A illustrates an example of wireless media delivery platform or system 100, such as Wi-Fi Miracast® platform or system, that includes various computing devices 102-118 connected to a Wi-Fi LAN and/or capable of utilizing Wi-Fi communications. In this system 100, the computing devices may exchange data with one another, such as frames or packets, messages, logs, etc., via wireless connections 120 and/or 122. For example, a smartphone 102 may receive MPEG streams via wireless connections 120 (e.g., Wi-Fi connections over the LAN 190, etc.) from a video camera 118 (e.g., an Internet or web cam, etc.), a wearable device 116 (e.g., a smart watch, etc.), a personal or desktop computer 114, and/or a digital camera 112. In such examples, the video camera 118, wearable device 116, personal or desktop computer 114, and/or the digital camera 112 may operate as source computing devices providing frames or packets to the smartphone 102 operating as a sink computing device. The smailphone 102 operating as the sink computing device may provide messages, such as acknowledgement messages, reply messages, logs, etc., to the video camera 118, wearable device 116, personal or desktop computer 114, and/or the digital camera 112 operating as source computing devices.

As further examples, the smartphone 102 may transmit MPEG streams via wireless connections 122 (e.g., Wi-Fi connections over the LAN 190, etc.) to a speaker device 104, a printer device 106, a display unit 108, and/or a head-mounted display (HMD) device 110. For example, to render a movie, the smartphone 102 may provide a video MPEG stream to the display unit 108 and an audio MPEG stream to the speaker device 104. In such examples, the smartphone 102 may operate as a source computing device providing access units (e.g., content frames, content packets, etc.) to the speaker device 104, the printer device 106, the display unit 108, and/or the HMD device 110 operating as sink computing devices. The speaker device 104, the printer device 106, the display unit 108, and/or the HMD device 110 operating as the sink computing devices may provide messages, such as acknowledgement messages, reply messages, logs, etc., to the smailphone 102 operating as a source computing device.

FIG. 1B is a component block diagram illustrating example components of a source computing device 148 and a sink computing device 149 configured for direct streaming with one another. With reference to FIGS. 1A-1B, the source computing device 148 may be any computing device (e.g., smailphone 102, speaker device 104, printer device 106, display unit 108, HMD device 110, video camera 118, wearable device 116, personal or desktop computer 114, digital camera 112, etc.) providing access units (e.g., content frames, content packets, etc.) to the sink computing device 149. Similarly, the sink computing device may be any computing device (e.g., smailphone 102, speaker device 104, printer device 106, display unit 108, HMD device 110, video camera 118, wearable device 116, personal or desktop computer 114, digital camera 112, etc.) receiving access units from the source computing device 148.

The source computing device 148 may include a media player component 150, a transport component 154, and a display component 152. The sink computing device 149 may include a media player component 170, a transport component 162, and a decoder component 166. The media player component 170 may send video frames to a display component 172.

As used herein, the term “component” refers to a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a computing device and the computing device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

The media player components 150, 170 may be combinations of one or more other components of the source computing device 148 and sink computing device 149, respectively. For example, a media player component may be a combination of a network element component configured to fetch data from a network, a decoder component configured to decode fetched compressed data, and a media renderer component configured to perform audio-visual (AV) synchronization operations. As an alternative example, a media player component may merely be a media renderer component that sends media data, such as decoded video frames to a display component, decoded audio samples to a sound card, etc. In some embodiments, the media player component 150 of the source computing device 148 may include different components than the media player component 170 of the sink computing device 149.

The media player component 150 of the source computing device 148 may send compressed access units to the transport component 154 to be sent to the sink computing device 149. The decoder component 166 may decode compressed access units and the resulting access unit may be processed by the AV synch operations of the media player component 150. The media player component 150 may include various internal components, such as AV synch components, decoder components, codec components, etc., configured to support playout of a compressed media stream. The media player component 150 may output access units to the display component 152 for rendering to a user of the source computing device 148. The media player component 150 may send notifications of operations performed on the compressed access units (e.g., notifications of presentation time stamps, notifications or decoding time stamps, notifications of AV synch operations, notifications of rendering an access unit, notifications of dropping an access unit, etc.) to the transport component 154. The display component 152 may control a screen, speaker, and/or other user interface to render the access units to the user.

The transport component 154 of the source computing device 148 may send packets, such as packets including compressed access units, packets including meta data, packets including messages, etc., to the transport component 162 of the sink computing device 149. The transport component 154 of the source computing device 148 may receive packets, such as packets including control information, session information, reply messages, etc., from the transport component 162 of the sink computing device 149. The transport component 162 of the sink computing device 149 may receive packets, such as packets including compressed access units, packets including meta data, packets including messages, etc., from the transport component 154 of the source computing device 148. The transport component 162 of the sink computing device 149 may send packets, such as packets including control information, session information, reply messages, etc., to the transport component 154 of the source computing device 148. As examples, the transport component 154 and the transport component 162 may each be components (e.g., Wi-Fi Miracast® components, Apple AirPlay® components, Wi-Di components, etc.) configured to establish Wi-Fi connections with one another and exchange communications over the established Wi-Fi connections.

The transport component 154 of the source computing device 148 may include a control component 156 configured to control operations of the transport component 154. As examples, the control component 156 may monitor the sending of packets by the transport component 154, may control the transmission bandwidth at which packets are sent by the transport component 154, may control an encoder component 158 to generate packets (e.g., transport packets, presentation packets, etc.), may direct packets to be stored, retrieved, and/or removed from one or more caches and/or buffers 160, may determine capabilities of the sink computing device 149 through capability messages, may monitor notifications from other components of the source computing device 148, such as the media player component 150, may indicate render statuses of packets handled by the media player component 150 to the sink computing device 149, etc. The transport component 154 may include an encoder component 158 configured to encode packets for transport to the sink computing device 149. For example, the encoder component 158 may generate transport packets and presentation packets for transmission to the sink computing device 149. In some modes of operation, the encoder component 158 may be used to encode frames captured from the display component 152. In some modes of operations, such as a direct streaming mode, the encoder component 158 may be bypassed and the encoder component 158 may not be used as compressed encoded packets may be tapped directly from the media player component 150 for transport. The transport component 154 may include one or more caches and/or buffers 160 configured to store packets and other data. As examples, the one or more caches and/or buffers 160 may include a transport packet buffer (e.g., a pre-transmit-queue, etc.) that may be a first-in-first-out (FIFO) queue storing transport packets for transmission to the sink computing device 149, the one or more caches and/or buffers 160 may include a presentation packet buffer (e.g., a packet time stamp buffer, a PES-packet-queue, a video-PES-packet-queue, etc.) that may be a FIFO queue storing presentation packets for transmission to the sink computing device 149, etc.

The transport component 162 of the sink computing device 149 may include a control component 164 configured to control operations of the transport component 162. As examples, the control component 164 may monitor the receipt of packets by the transport component 162, may direct packets to be stored, retrieved, and/or removed from one or more caches and/or buffers 168, may control the decoder component 166 to decode packets from the source computing device 148, may indicate capabilities to the source computing device 148 through reply messages, may determine render statuses indicated by the source computing device 148, may drop decoded packets (e.g., drop decoded compressed access units, etc.), may send decoded packets (e.g., decoded compressed access units, etc.) to the media player component 170 of the sink computing device 149, etc. The transport component 162 may include a decoder component 166 configured to decode packets received from the source computing device 148. For example, the decoder component 166 may decode transport packets and presentation packets received from the source computing device 148. The transport component 162 may include one or more caches and/or buffers 168 configured to store packets and other data. As examples, the one or more caches and/or buffers 168 may include a decoded packet buffer (e.g., a pre-transmitted data buffer, compressed access unit cache, etc.) that may store data from decoded transport packets (e.g., compressed access units, etc.) received from the source computing device 148.

The media player component 170 of the sink computing device 149 may receive compressed access units from the transport component 162 sent from the source computing device 148. The media player component 170 may decode compressed access units, for example via controlling operations of the decoder component 166, and the resulting access unit may be processed by the AV synch operations of the media player component 170. The media player component 170 may include various internal components, such as AV synch components, decoder components, codec components, etc., configured to support playout of a compressed media stream. The media player component 170 (e.g., a renderer component of the media player component 170) may output access units to the display component 172 for rendering to a user of the sink computing device 149. The display component 172 may control a screen, speaker, and/or other user interface to render the access units to the user.

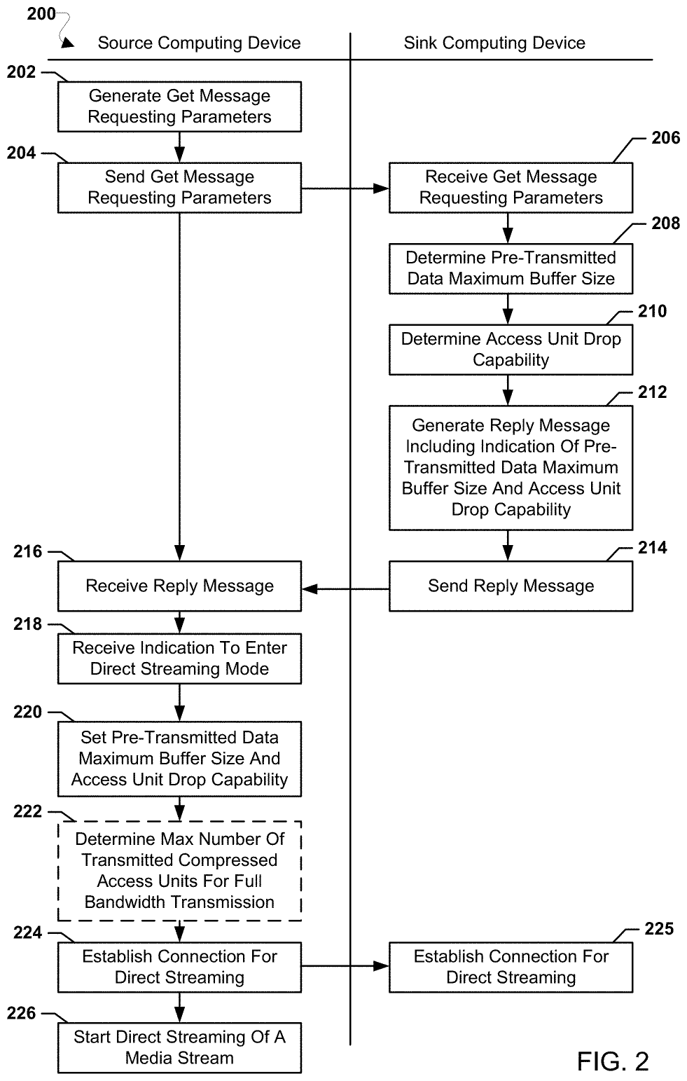

FIG. 2 illustrates a method 200 for establishing direct streaming between a source computing device and a sink computing device according to some embodiments. With reference to FIGS. 1A-2, the method 200 may be performed by a processor of a source computing device, such as a processor of the source computing device 148, and a processor of a sink computing device, such as a processor of the sink computing device 149. Capabilities are often negotiated via control messages before any data flow, such as data flow in a mirroring mode, occurs. Messages requesting and providing parameters, such as Get messages and Set messages, may be exchanged by sink computing devices and source computing devices prior to any data flow between the devices.

In block 202, the processor of the source computing device may generate a Get message requesting parameters. In some embodiments, the Get message may be a RTSP request message. For example, the Get message may be a Get parameter message (e.g., GET_PARAMETER) with an element requesting pre-transmitted data capabilities (e.g., pre-transmit-data).

In block 204, the processor of the source computing device may send the Get message requesting parameters to the sink computing device. For example, the processor of the source computing device may send the Get message via M3/M4 messages. In block 206, the processor of the sink computing device may receive the Get message requesting parameters.

In block 208, the processor of the sink computing device may determine a pre-transmitted data maximum buffer size. In some embodiments, the pre-transmitted data maximum buffer size may be the maximum amount of pre-transmitted video-data for which the corresponding keyed-MPEG-2 PES packet has not yet been transmitted that the sink computing device may store. This pre-transmitted data maximum buffer size may be independent of any private pre-roll on the sink computing device side. The pre-transmitted data maximum buffer size may represent a contract of the amount of pre-transmitted data that the sink computing device will accept from the source computing device without pausing socket reads or discarding earlier pre-transmitted access units. As an example, the pre-transmitted data maximum buffer size may be an element “max-video-buf.” The pre-transmitted data maximum buffer size may be determined by the processor of the sink computing device by determining an amount of memory space allocated to storing pre-transmitted data. In some embodiments, the pre-transmitted data maximum buffer size may be a pre-set value on the sink computing device. In some embodiments, the pre-transmitted data maximum buffer size may be a dynamic value.

In block 210, the processor of the sink computing device may determine an access unit drop capability. An access unit drop capability may indicate the sink computing device's ability to render or drop decoded access units based on the render-status received from a source computing device. The access unit drop capability may be based on the capability of the media player component (e.g., media player component 170) of the sink computing device.

In block 212, the processor of the sink computing device may generate a Reply message including an indication of the pre-transmitted data maximum buffer size and an indication of the access unit drop capability. In some embodiments, the Reply message may be an RTSP reply message. For example, the Reply message may be a RTSP reply with an element indicating the pre-transmitted data maximum buffer size (e.g., pre-transmit-data-max-video-buf=SMB when the maximum buffer size is 5 MB). In such an example, the presence of the pre-transmitted data maximum buffer size in the Reply message may itself be an indication that the sink computing device has the ability to render or drop decoded access units based on indications from the source computing device. As another example, the Reply message may include separate indications of the pre-transmitted data maximum buffer size (e.g., aux_stream_meta pre-transmit-data-max-video-buf=SMB when the maximum buffer size is 5MB) and the access unit drop capability (e.g., aux_stream_meta render action).

In block 214, the processor of the sink computing device may send the Reply message to the source computing device. For example, the processor of the sink computing device may send the Reply message via M3/M4 messages. In block 216, the processor of the source computing device may receive the Reply message from the sink computing device. In some embodiments, the reply message and/or the indications and/or other attributes of the reply message may be stored by the source computing device until a direct streaming mode is entered.

In block 218, the processor of the source computing device may receive an indication to enter a direct streaming mode. For example, the processor of the source computing device may receive an indication from a media player component (e.g., media player component 150) to start direct streaming a media stream to a sink computing device (e.g., sink computing device 149).

In block 220, the processor of the source computing device may set a pre-transmitted data maximum buffer size and access unit drop capability. The provisioning of the pre-transmitted data maximum buffer size may indicate the capability of the sink computing device to accept pre-transmitted video access-units on MPEG-2 is private stream 2, cache those pre-transmitted video access-units on receipt, and later render those transmitted video access-units when the corresponding keyed-PES packet for the pre-transmitted access-units is received. The processor of the source computing device may set the pre-transmitted data maximum buffer size in memory. Additionally, the processor of the source computing device may generate and send a parameter message to the sink computing device confirming the pre-transmitted data maximum buffer size was set, such as a RTSP Set parameter message (e.g., SET PARAM) with an attribute indicating the set buffer size (e.g., aux stream meta pre-transmit-data-max-video-buf=5 MB when the maximum buffer size is 5 MB). Similarly, the sink computing device may send in response a RTSP reply, such as a 200 OK type message.

In optional block 222, the processor of the source computing device may determine a maximum number of transmitted compressed access units for full bandwidth transmission. For example, the processor of the source computing device may divide the indicated pre-transmitted data maximum buffer size of the sink computing device by the compressed access unit size to determine the maximum number of transmitted compressed access units for full bandwidth transmission. As another example, the maximum number of transmitted compressed access units for full bandwidth transmission may be a preset value on the source computing device. In some embodiments, the maximum number of transmitted compressed access units for full bandwidth transmission may be defined as ‘d’, the number of frames to pre-transmit with full bandwidth utilization. ‘d’ may be selected by the source computing device to ensure that a number large enough to at least satisfy the decoder-buffer-depth are pre-transmitted with highest priority. Block 222 may be optional, as transmission bandwidth changes by the source computing device may be optional in some embodiments.

In block 224, the processor of the source computing device may establish a connection for direct streaming with the sink computing device and in block 225 the processor of the sink computing device may establish a connection for direct streaming with the source computing device. For example, the connections may be Wi-Fi type connections, such as Wi-Fi Miracast® connections, Apple AirPlay® connections, Wi-Di connections, etc. Via the connections established between the source computing device and the sink computing device, the source computing device and the sink computing device may exchange communications with one another in a direct streaming mode.

In block 226, the processor of the source computing device may start direct streaming of a media stream. For example, the media player component (e.g., media player component 150) of the source computing device may begin sending compressed access units to the transport component (e.g., transport component 154) of the source computing device for transmission to the sink computing device.

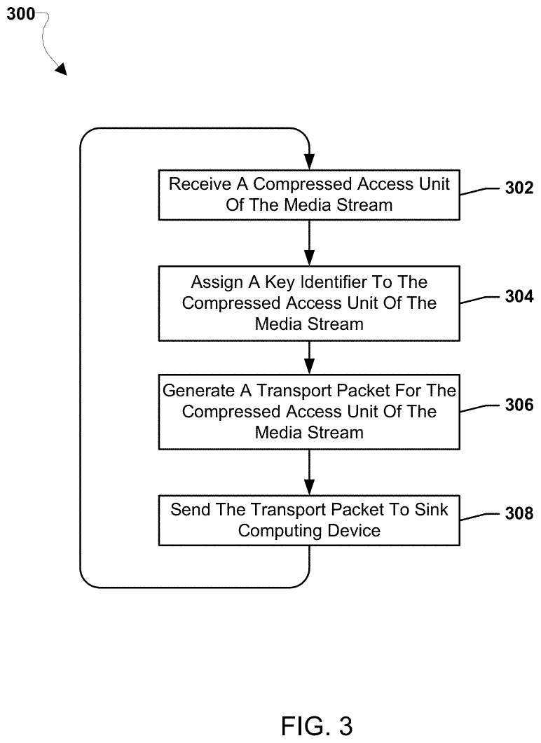

FIG. 3 illustrates a method 300 for streaming a compressed media stream according to some embodiments. With reference to FIGS. 1A-3, the method 300 may be performed by a processor of a source computing device, such as a processor of the source computing device 148. In some embodiments, the operations of the method 300 may be performed in conjunction with the operations of the method 200. In some embodiments, the operations of the method 300 may be performed in response to the source computing device starting direct streaming of a media stream.

In block 302, the processor of the source computing device may receive a compressed access unit of the media stream. For example, the transport component (e.g., transport component 154) of the source computing device may receive a compressed access unit from the media player component (e.g., media player component 150) of the source computing device. The compressed access unit may be a video access unit, an audio access unit, etc.

In block 304, the processor of the source computing device may assign a key identifier to the compressed access unit of the media stream. Access units may be uniquely numbered (e.g., 0, 1, 2, 3, . . . i), whether in a compressed or decoded state. The processor of the source computing device may generate a unique key identifier, for example for the compressed access unit. The unique key identifier may be used to track the compressed access unit separately from any other compressed access unit. The processor of the source computing device may maintain a mapping of assigned key identifiers and original access unit numbering.

In block 306, the processor of the source computing device may generate a transport packet for the compressed access unit of the media stream. Generating the transport packet may include encoding the compressed access unit and the assigned key identifier into a packet suitable for Wi-Fi transmission. For example, the processor of the source computing device may generate a transport packet that includes the compressed access unit and that indicates the assigned key identifier. The transport packet may be a tuple of the assigned key identifier and the compressed access unit (e.g., {<key>,<video access-unit>}). In some embodiments, the transport packet may be a keyed-PES packet.

In block 308, the processor of the source computing device may send the transport packet to a sink computing device. Sending the transport packet may include directly sending the transport packet to the sink computing device and/or buffering the transport packet, such as in a pre-transmit-queue, prior to transmission to the sink computing device. The transport packet may be sent over a Wi-Fi type connection to the sink computing device, such as Wi-Fi Miracast® connection, Apple AirPlay® connection, Wi-Di connection, etc. For example, the compressed access-unit may be sent in a transport packet in an MPEG-2 is private stream 2.

The processor of the source computing device may receive the next compressed access unit of the media stream in block 302. In this manner, the processor may perform the method 300 continually as compressed access units may be received.

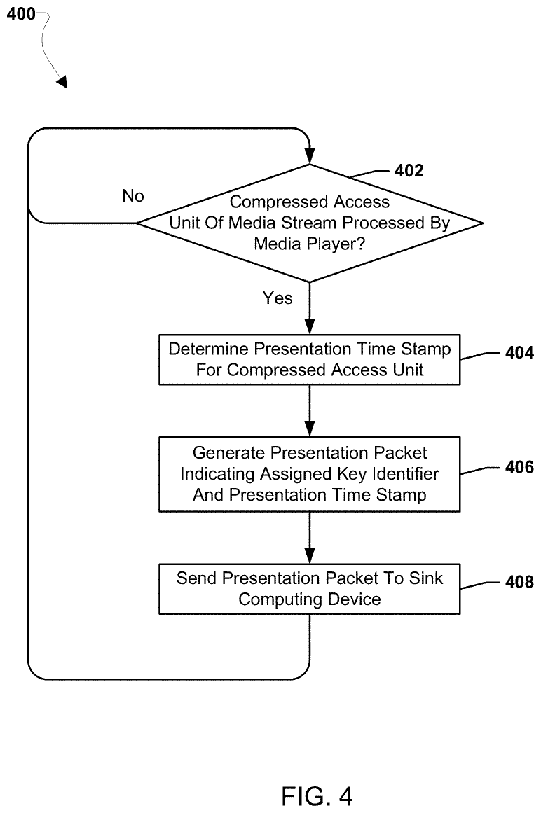

FIG. 4 illustrates a method 400 for streaming a compressed media stream according to some embodiments. With reference to FIGS. 1A-4, the method 400 may be performed by a processor of a source computing device, such as a processor of the source computing device 148. In some embodiments, the operations of the method 400 may be performed in conjunction with the operations of the methods 200 and/or 300. In some embodiments, the operations of the method 400 may be performed in response to the source computing device starting direct streaming of a media stream.

In determination block 402, the processor of the source computing device may determine whether a compressed access unit of a media stream has been processed by a media player. This determination may be made based on a notification from a media player component (e.g., media player component 150) of the source computing device. The notifications may be various types of notifications (e.g., notifications of presentation time stamps, notifications or decoding time stamps, notifications of AV synch operations, notifications of rendering an access unit, notifications of dropping an access unit, etc.) and may indicate the unique number of the access unit that was processed. The processor of the source computing device may match the unique number of the access unit that was processed to the key identifier assigned to that same compressed access unit that was previously received.

In response to determining that a compressed access unit of the media stream has not been processed by the media player (i.e., determination block 402 =“No”), the processor of the source computing device may continue to determine whether a compressed access unit of a media stream has been processed by a media player in block 402.

In response to determining that a compressed access unit of the media stream has been processed by the media player (i.e., determination block 402=“Yes”), the processor of the source computing device may determine a presentation time stamp for the compressed access unit in block 404. The presentation time stamp may be indicated in a notification and the processor may parse the notification to determine the timestamp.

In block 406, the processor of the source computing device may generate a presentation packet indicating the assigned key identifier and a presentation time stamp. For example, the presentation packet may be a keyed-MPEG-2 PES packet. Rather than including any access unit data, the presentation packet may include the key identifier of the compressed access unit from which the access unit was decoded.

In block 408, the processor of the source computing device may send the presentation packet to a sink computing device. Sending the presentation packet may include directly sending the presentation packet to the sink computing device and/or buffering the presentation packet, such as in a video-PES-packet-queue, prior to transmission to the sink computing device. The presentation packet may be sent over a Wi-Fi type connection to the sink computing device, such as Wi-Fi Miracast® connection, Apple AirPlay® connection, Wi-Di connection, etc.

In response to sending the presentation packet to the sink computing device, the processor of the source computing device may again determine whether a compressed access unit of a media stream has been processed by a media player in block 402. In this manner, the method 400 may be performed continually as compressed access units are processed.

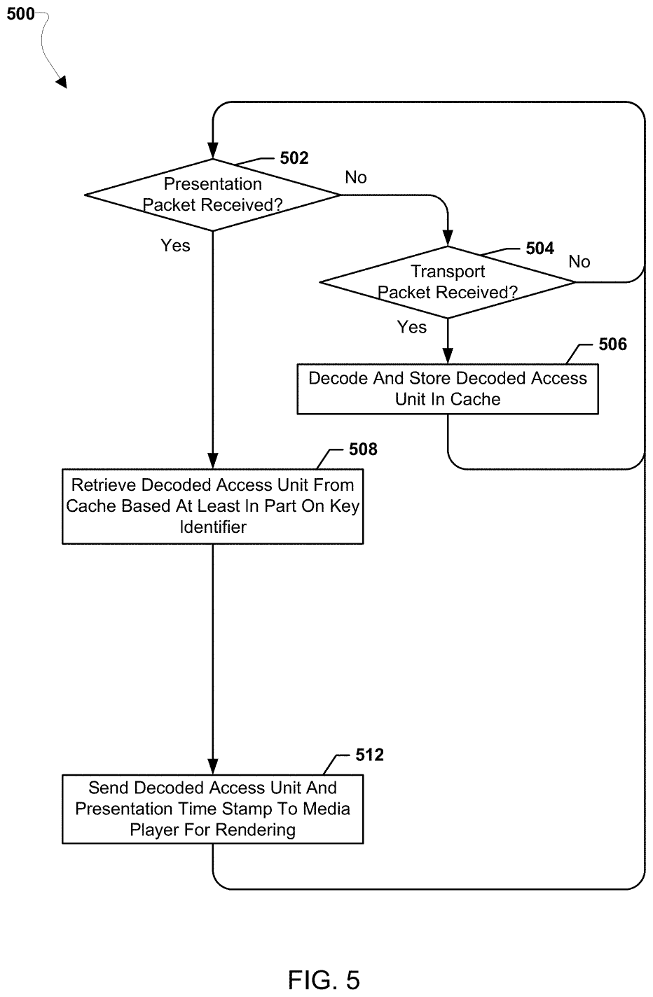

FIG. 5 illustrates a method 500 for streaming a compressed media stream according to some embodiments. With reference to FIGS. 1A-5, the method 500 may be performed by a processor of a sink computing device, such as a processor of the sink computing device 149. In some embodiments, the operations of the method 500 may be performed in conjunction with the operations of the methods 200, 300, and/or 400.

In determination block 502, the processor of the sink computing device may determine whether a presentation packet is received. For example, the processor of the sink computing device may determine whether a presentation packet may be received over a Wi-Fi type connection with a source computing device, such as a Wi-Fi Miracast® connection, Apple AirPlay® connection, Wi-Di connection, etc. As examples, the processor of the sink computing device may determine a port or timing slot over which a packet was received to determine whether a presentation packet was received, may parse a packet element (e.g., a header, footer, etc.) to determine a type of packet received, etc.

In response to determining that a presentation packet was not received (i.e., determination block 502 =“No”), the processor of the sink computing device may determine whether a transport packet is received in determination block 504. For example, the processor of the sink computing device may determine whether a transport packet is received over a Wi-Fi type connection with a source computing device, such as a Wi-Fi Miracast® connection, Apple AirPlay® connection, Wi-Di connection, etc. As examples, the processor of the sink computing device may determine a port or timing slot over which a packet was received to determine whether a transport packet was received, may parse a packet element (e.g., a header, footer, etc.) to determine a type of packet received, etc. As a specific example, a packet being received over an MPEG-2 is private stream 2 may indicate that a packet is a transport packet.

In response to determining that a transport packet was received (i.e., determination block 504=“Yes”), the processor of the sink computing device may decode and store the decoded access unit in a cache in block 506. For example, the processor of the sink computing device may decode the transport packet to reconstitute the original compressed access unit and store the compressed access unit in the transport packet in a packet buffer. The packet buffer (e.g., a pre-transmitted data buffer, compressed access unit cache, etc.) may be configured to store compressed access units received from a source computing device.

In response to storing the compressed access unit in a cache or in response to determining that a transport packet was not received (i.e., determination block 504=“No”), the processor of the sink computing device may determine whether a presentation packet is received in determination block 502.

In response to determining that a presentation packet was received (i.e., determination block 502=“Yes”), the processor of the sink computing device may retrieve the decoded access unit from the cache based at least in part on the key identifier in block 508. For example, the presentation packet may indicate the key identifier of the compressed access unit the presentation packet is associated with, and the processor of the sink computing device may retrieve the previously stored compressed access unit also associated with the same key identifier.

In block 512, the processor of the sink computing device may send the decoded access unit and the presentation time stamp to a media player (e.g., media player component 170) for rendering. The media player of the sink computing device may receive compressed access units and presentation times stamp, may decode the compressed access units using the presentation time stamp, and the resulting access units may be processed by the AV synch operations of the media player.

In response to sending the compressed access unit and presentation time stamp to the media player for rendering the processor of the sink computing device may again determine whether a presentation packet is received in determination block 502. In this manner, the method 500 may be performed continually as packets are received at the sink computing device.

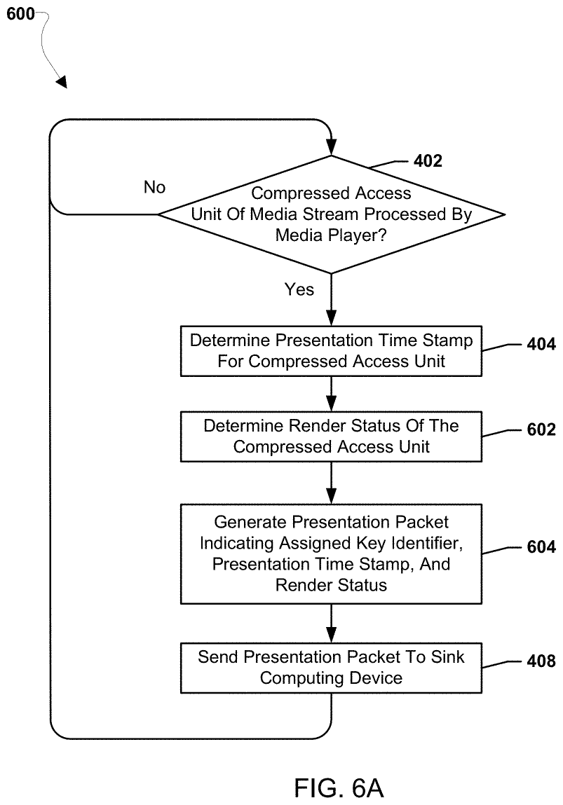

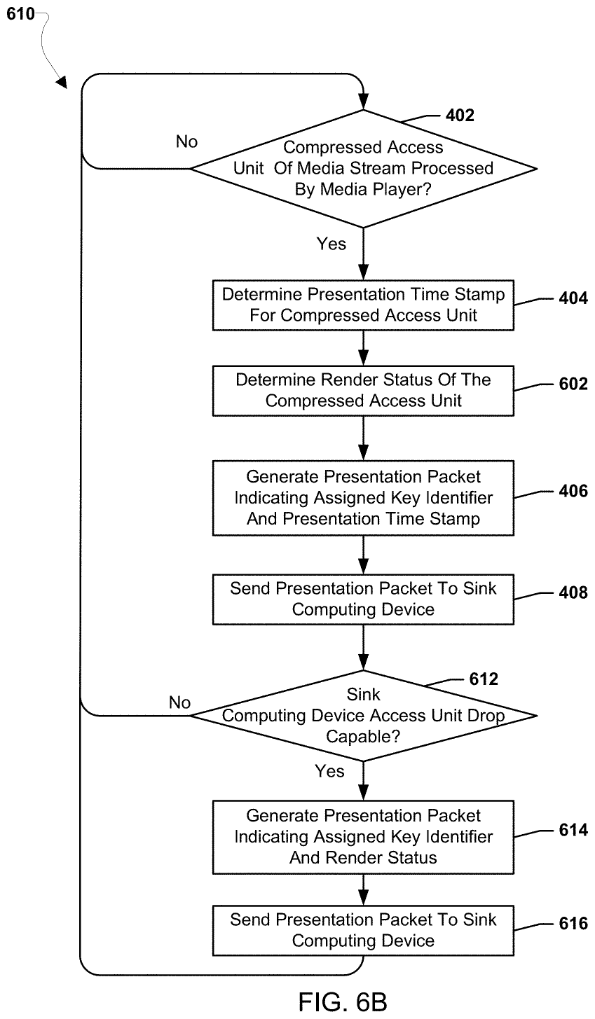

FIG. 6A illustrates a method 600 for streaming a compressed media stream according to some embodiments. With reference to FIGS. 1A-6A, the method 600 may be performed by a processor of a source computing device, such as a processor of the source computing device 148. In some embodiments, the operations of the method 600 may be performed in conjunction with the operations of the methods 200, 300, and/or 500. In some embodiments, the operations of method 600 may be performed in response to the source computing device starting direct streaming of a media stream.

In blocks 402 and 404, the processor of the source computing device may perform operations of like numbered blocks of the method 400 described with reference to FIG. 4.

In block 602, the processor of the source computing device may determine a render status of the compressed access unit. Access units may be dropped by source computing devices for various reasons, including pausing occurring, fast forwarding occurring, rewinding occurring, or any other reason. The determination of whether a compressed access unit of a media stream was rendered or dropped by a media player may be based on a notification from a media player component (e.g., media player component 150) of the source computing device. The notifications may be various types of notifications (e.g., notifications of rendering an access unit, notifications of dropping an access unit, etc.) and may indicate the unique number of the access unit that was rendered or dropped. The processor of the source computing device may match the unique number of the access unit that was rendered or dropped to the key identifier assigned to that same compressed access unit that was previously received to determine the render status of the compressed access unit.

In block 604, the processor of the source computing device may generate a presentation packet indicating the assigned key identifier, a presentation time stamp, and the render status. For example, the presentation packet may be a Keyed-MPEG-2 PES packet. Rather than including any access unit data, the presentation packet may include the key identifier of the compressed access unit from which the access unit was decoded. In some embodiments, the presentation packet may indicate the key identifier, the presentation time stamp for the compressed access unit, and the render status of the compressed access unit. The render status may be an indication of whether the media player rendered the access unit decoded from the compressed access unit or dropped the access unit decoded from the compressed access unit. For example, a PES packet for a compressed access unit with the key identifier ‘1033’ may include the data element “Video PES-data: {key=1033 render-action=render}” when that compressed access unit was rendered and may include the data element “Video PES-data: {key=1033 render-action=drop}” when that compressed access unit was dropped. Timing information, such as the presentation time stamp, decoding time stamp, etc. and other metadata may be filled in corresponding fields of the PES packet.

In block 408, the processor of the source computing device may perform operations of the like numbered block described of the method 400 with reference to FIG. 4.

FIG. 6B illustrates a method 610 for streaming a compressed media stream according to some embodiments. With reference to FIGS. 1A-6B, the method 610 may be performed by a processor of a source computing device, such as a processor of the source computing device 148. In some embodiments, the operations of the method 610 may be performed in conjunction with the operations of the methods 200, 300, and/or 500. In some embodiments, the operations of method 610 may be performed in response to the source computing device starting direct streaming of a media stream.

In blocks 402 and 404, the processor of the source computing device may perform operations of like numbered blocks of the method 400 described with reference to FIG. 4. In block 602, the processor of the source computing device may perform operations of the like numbered block of the method 600 described with reference to FIG. 6A. In block 406 and 408, the processor of the source computing device may perform operations of like numbered blocks of the method 400 described with reference to FIG. 4.

In determination block 612, the processor of the source computing device may determine whether the sink computing device is access unit drop capable. A sink computing device may indicate an access unit drop capability to the source computing device, such as via control messages exchanged by the source and sink computing device. The access unit drop capability may indicate the sink computing device's ability to render or drop decoded access units received from a source computing device. A sink computing device that is access unit drop capable may be capable of selectively dropping decoded access units based on indications from the source computing device. A sink computing device that is not access unit drop capable may not be configured to drop decoded access units based on indication from the source computing device. The access unit drop capability may be based on the capability of the media player component (e.g., media player component 170) of the sink computing device. The capabilities of the sink computing device may be stored in a memory of the source computing device and the processor of the source computing device may reference such stored information in a memory to determine whether the sink computing device is access unit drop capable.

In response to determining that the sink computing device is not access unit drop capable (i.e., determination block 612=“No”), in determination block 402, the processor of the source computing device may perform operations of the like numbered block of the method 400 described with reference to FIG. 4.

In response to determining that the sink computing device is access unit drop capable (i.e., determination block 612=“Yes”), the processor of the source computing device may generate a presentation packet indicating the assigned key identifier and the render status in block 614. For example, the presentation packet may be a MPEG-2 PES packet. Rather than including any access unit data, the presentation packet may include the key identifier of the compressed access unit. In some embodiments, the presentation packet may indicate the key identifier and the render status of the compressed access unit. The render status may be an indication of whether the media player rendered the access unit decoded from the compressed access unit or dropped the access unit decoded from the compressed access unit. For example, a PES packet data for a compressed access unit with the key identifier ‘1033’ may include the data element “Video PES-data: {key=1033 render-action=render} when that compressed access unit was rendered and may include the data element “Video PES-data: {key=1033 render-action=drop} when that compressed access unit was dropped.

In block 616, the processor of the source computing device may send the presentation packet to the sink computing device. Sending the presentation packet may include directly sending the presentation packet to the sink computing device and/or buffering the presentation packet, such as in a video-PES-packet-queue, prior to transmission to the sink computing device. The presentation packet may be sent over a Wi-Fi type connection to the sink computing device, such as Wi-Fi Miracast® connection, Apple AirPlay® connection, Wi-Di connection, etc. For example, the presentation packet may be sent in an MPEG-2 is private stream 2. In this manner, in response to a sink computing device being determined to be access unit drop capable, the sink computing device may be sent two presentation packets, one with the assigned key identifier and presentation time stamp indicated and one with the assigned key identifier and render status indicated. The two presentation packets may be sent separately, such as over two different transport streams.

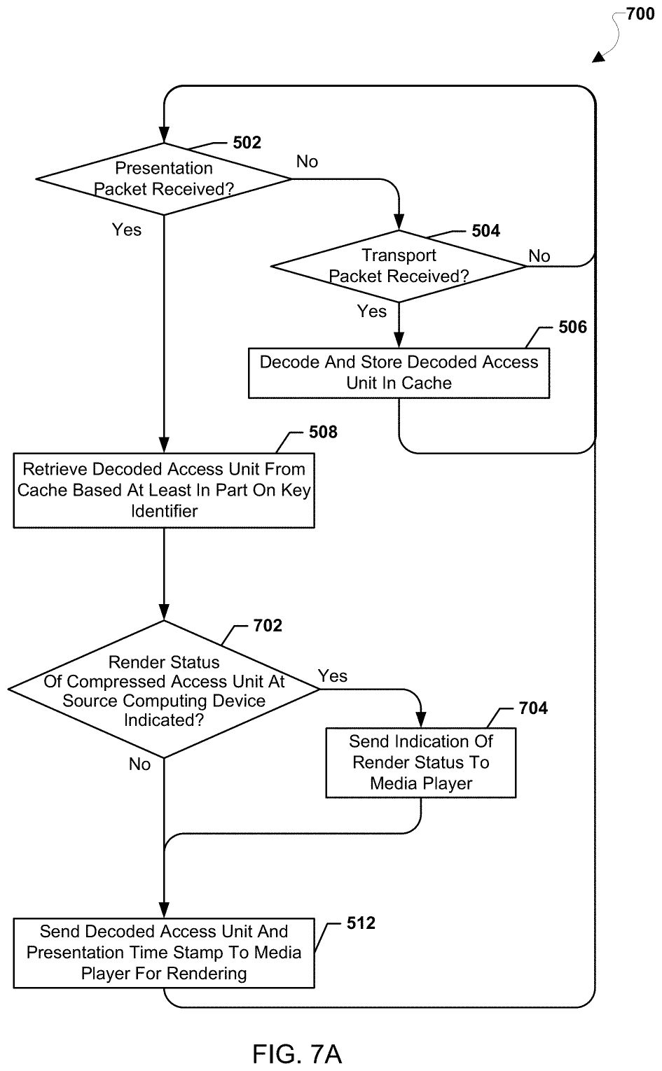

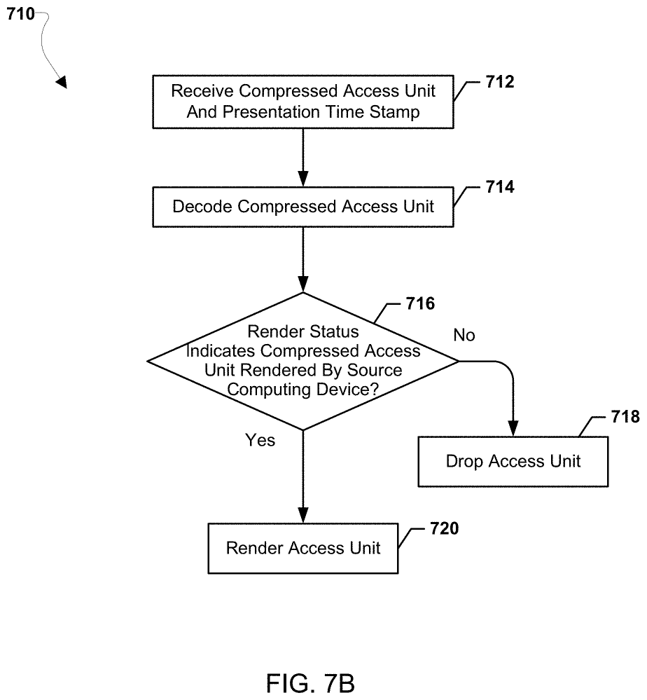

FIG. 7A illustrates a method 700 for streaming a compressed media stream according to some embodiments. With reference to FIGS. 1A-7A, the method 700 may be performed by a processor of a sink computing device, such as a processor of the sink computing device 149. In some embodiments, the operations of the method 700 may be performed in conjunction with the operations of the methods 200, 300, 400, 600, and/or 610.

101011 In blocks 502, 504, 506, 508, and 510, the processor of the sink computing device may perform operations of like numbered blocks of the method 500 described with reference to FIG. 5.

In determination block 702, the processor of the sink computing device may determine whether render status of the compressed access unit at the source computing device is indicated. Access units may be dropped by source computing devices for various reasons, including pausing occurring, fast forwarding occurring, rewinding occurring, or any other reason. The render status may be an indication of whether the media player at the source computing device rendered the access unit decoded from the compressed access unit or dropped the access unit decoded from the compressed access unit.

Render statuses may be indicated in presentation packets received by the sink computing device from the source computing device. For example, a keyed-PES packet for a compressed access unit with the key identifier ‘1033’ may include the data element “Video PES-data: {key=1033 render-action=render}” when that compressed access unit was rendered and may include the data element “Video PES-data: {key=1033 render-action=drop}” when that compressed access unit was dropped. The presence of a data element associated with a render action in the PES packet may indicate whether or not the render status of the compressed access unit is indicated. A data element associated with a render action may indicate the render status is indicated and the lack of a data element associated with a render action may indicate the render status is not indicated. Render statuses may be received in presentation packets including the presentation time stamp for the compressed access unit and/or may be received in presentation packets sent separately from those indicating the presentation time stamp.

In response to determining that the render status of the compressed access unit at the source computing device is not indicated (i.e., determination block 702=“No”), the processor of the sink computing device may send the compressed access unit and presentation time stamp to the media player for rendering in block 512 as described for the like numbered block of the method 500 with reference to FIG. 5.

In response to determining that the render status of the compressed access unit is indicated (i.e., determination block 702 =“Yes”), the processor of the sink computing device may send an indication of the render status to the media player in block 704. For example, the indication of the render status may be an indication that the media player at the source computing device rendered the access unit decoded from the compressed access unit (e.g., an indication of “render-action=render”) or an indication that the media player at the source computing device dropped the access unit decoded from the compressed access unit (e.g., an indication of “render-action=drop”). The indication may be the render status indicated in a presentation packet associated with the compressed access unit, such as a presentation packet having the same key identifier as the compressed access unit, received by the sink computing device from the source computing device. The indication of the render status may be sent to the media player as a separate message to the media player and/or may be sent with the compressed access unit and/or presentation time stamps.

In block 512, the processor of the sink computing device may send the compressed access unit and presentation time stamp to the media player for rendering as described for the like numbered block of the method 500 with reference to FIG. 5. The media player may render or drop the compressed access unit after decoding the compressed access unit based at least in part on the indication of the render status.

FIG. 7B illustrates a method 710 for streaming a compressed media stream according to some embodiments. With reference to FIGS. 1A-7B, the method 710 may be performed by a processor of a sink computing device, such as a processor of the sink computing device 149. As a specific example, the operations of method 710 may be performed by a media player running on a processor of a sink computing device, such as media player component 170 of sink computing device 149. In some embodiments, the operations of the method 710 may be performed in conjunction with the operations of the methods 200, 300, 400, 600, 610, and/or 700.

In block 712, the processor of the sink computing device may receive a compressed access unit and presentation time stamp. The compressed access unit may be an access unit that was sent to the sink computing device from a source computing device and the presentation time stamp may be an indication of the presentation time stamp determined from AV synch operations at the source computing device.

In block 714, the processor of the sink computing device may decode the compressed access unit. Decoding the compressed access unit may include applying various operations to the compressed access unit to convert the encoded state compressed access unit into a decoded state access unit that is renderable such as an audio frame, video frame (e.g., I-frames, P-frames, B-frames, etc.).

In determination block 716, the processor of the sink computing device may determine whether the render status indicates that the compressed access unit was rendered by the source computing device. Access units may be dropped by source computing devices for various reasons, including pausing occurring, fast forwarding occurring, rewinding occurring, or any other reason. The render status may be an indication of whether the media player at the source computing device rendered the access unit decoded from the compressed access unit or dropped the access unit decoded from the compressed access unit. For example, a keyed-PES packet for a compressed access unit with the key identifier ‘1033’ may include the data element {key=1033 render-action=render} when that compressed access unit was rendered and may include the data element {key=1033 render-action=drop} when that compressed access unit was dropped. An indication of the render status may have been sent to the media player from a transport component (e.g., transport component 162) of the sink computing device. For example, the indication of the render status may be an indication that the media player at the source computing device rendered the access unit decoded from the compressed access unit (e.g., an indication of “render-action=render”) or an indication that the media player at the source computing device dropped the access unit decoded from the compressed access unit (e.g., an indication of “render-action=drop”). The indication of the render status may have been sent to the media player as a separate message to the media player and/or may have been sent with the compressed access unit and/or presentation time stamps.

In response to determining that the compressed access unit was not rendered by the source computing device (i.e., determination block 716=“No”), the processor of the sink computing device may drop the decoded access unit in block 718. In this manner, access units that were dropped by the source computing device may also be dropped by the sink computing device. Matching of dropped access units between sink computing devices and source computing devices may prevent artifacts in sink computing device playout in which access units that may not be rendered at the source computing device are played out at the sink computing device.

In response to determining that the compressed access unit was rendered by the source computing device (i.e., determination block 716=“Yes”), the processor of the sink computing device may render the access unit in block 720. In this manner, access units that were actually rendered by the source computing device may also be rendered by the sink computing device.

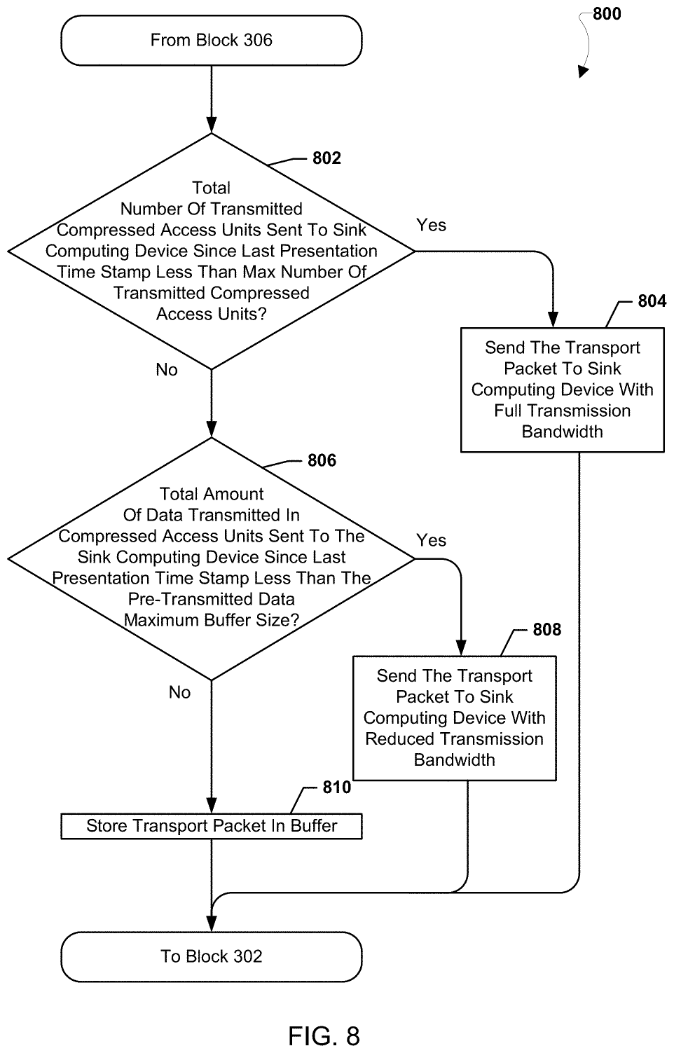

FIG. 8 illustrates a method 800 for sending a transport packet to a sink computing device according to some embodiments. With reference to FIGS. 1A-8, the method 800 may be performed by a processor of a source computing device, such as a processor of the source computing device 148. In some embodiments, the operations of the method 800 may be performed in conjunction with the operations of the methods 200, 300, 400, 500, 600, 610, 700, and/or 710. In some embodiments, the operations of the method 800 may be performed in response to generating a transport packet for the compressed access unit of the media stream in block 306 of the method 300 as described.

In some embodiments, the processor of the source computing device may track the compressed access units sent for pre-transmission in transport packets and the presentation time stamps sent in presentation packets. For example, when any compressed access unit ‘i’ is sent in a transport packet, the processor of the source computing device may update the value of a total sent data with that access unit (i)'s size (e.g., pre_transmitted_data_size=pre_transmitted_data_size+access_unit_size(i)). Similarly, when the presentation time stamp corresponding to that access unit ‘i’ is sent in a presentation packet, the processor of the source computing device may update the value of a total sent data by subtracting that access unit (i)'s size (e.g., pre_transmitted_data_size=pre_transmitted_data_size−access_unit_size(i)). Additionally, in some embodiments, the processor of the source computing device may track the number of transmitted compressed access units sent to the sink computing device since a last presentation time stamp was sent in a presentation packet to the sink computing device. For example, the processor of the source computing device may increment a counter each time a transport packet is sent to the sink computing device and reset the counter to zero each time a presentation packet is sent to the sink computing device.

In determination block 802, the processor of the source computing device may determine whether the total number of transmitted compressed access units sent to the sink computing device since the last presentation time stamp is less than the maximum number of transmitted compressed access units. The maximum number of transmitted compressed access units may correspond to a determined maximum number of transmitted compressed access units for full bandwidth transmission. In some embodiments, the maximum number of transmitted compressed access units for full bandwidth transmission may be defined as ‘d’, the number of frames to pre-transmit with full bandwidth utilization. The maximum number of transmitted compressed access units ‘d’ may be selected by the source computing device to ensure the number is large enough to at least satisfy the decoder-buffer-depth are pre-transmitted with highest priority. For example, ‘d’ may be five access units. The processor of the source computing device may determine whether the total number of transmitted compressed access units sent to the sink computing device since the last presentation time stamp is less than the maximum number of transmitted compressed access units by comparing a counter tracking the number of transmit packets sent since the last presentation packet was sent to the maximum number of transmitted compressed access units for full bandwidth transmission ‘d’. The counter being less than ‘d’ may indicate the total number of transmitted compressed access units sent to the sink computing device since the last presentation time stamp is less than the maximum number of transmitted compressed access units. Similarly, the counter being greater than or equal to ‘d’ may indicate the total number of transmitted compressed access units sent to the sink computing device since the last presentation time stamp is not less than the maximum number of transmitted compressed access units.

In response to determining that the total number of transmitted compressed access units sent to the sink computing device since the last presentation time stamp is less than the maximum number of transmitted compressed access units (i.e., determination block 802=“Yes”), the processor of the source computing device may send the transport packet to the sink computing device with a full transmission bandwidth in block 804. In this manner, while the total number of transmitted compressed access units sent to the sink computing device since the last presentation time stamp is less than the maximum number of transmitted compressed access units any transport packet for which no presentation packet has been sent may be transmitted to the sink computing device. Upon sending the transport packet with a full transmission bandwidth, the source computing device may receive another compressed access unit of the media stream in block 302 of the method 300 as described.

In response to determining that the total number of transmitted compressed access units sent to the sink computing device since the last presentation time stamp is not less than the maximum number of transmitted compressed access units (i.e., determination block 802=“No”), the processor of the source computing device may determine whether the total amount of data in transmitted compressed access units sent to the sink computing device since the last presentation time stamp is less than the pre-transmitted data maximum buffer size in determination block 806. As the processor of the source computing device may track the value of the total data sent to the sink computing device (e.g., via the value pre_transmitted_data_size), the processor may compare the value of the total data sent to the sink computing device (e.g., via the value pre_transmitted_data size) to the pre-transmitted data maximum buffer size of the sink computing device, such as the pre-transmitted data maximum buffer size of the sink computing device indicated during capability negotiations. The total size of sent data being equal to or large than the pre-transmitted data maximum buffer size may indicate the sink computing device has no additional capability to store pre-transmitted compressed access units. The total size of sent data being less than the pre-transmitted data maximum buffer size may indicate the sink computing device has some additional capability to store pre-transmitted compressed access units.

In response to determining that the total amount of data in transmitted compressed access units sent to the sink computing device since the last presentation time stamp is less than the pre-transmitted data maximum buffer size (i.e., determination block 808=“Yes”), the processor of the source computing device may send the transport packet to the sink computing device with a reduced transmission bandwidth in block 808. For example, the source computing device may send bytes of the transport packet with increased time delays between subsequent bytes to reduce the transmission bandwidth. The sending of the transport packet with a reduced transmission bandwidth may give more priority to a presentation packet in transmission when a presentation packet becomes ready for transmission to the sink computing device. Upon sending the transport packet with a reduced transmission bandwidth, the source computing device may receive another compressed access unit of the media stream in block 302 of the method 300 as described.

In response to determining that the total amount of data in transmitted compressed access units sent to the sink computing device since the last presentation time stamp is not less than the pre-transmitted data maximum buffer size (i.e., determination block 808=“No”), the processor of the source computing device may store the transport packet in a buffer in block 810. As the total amount of transmitted data being equal to or large than the pre-transmitted data maximum buffer size may indicate the sink computing device has no additional capability to store pre-transmitted compressed access units, holding transport packets may avoid exceeding the storage requirements of the sink computing device. The storage of transport packets by the source computing device when the sink computing device storage is full may prevent unwanted sink computing device operations that can occur when an amount of pre-transmitted compressed access units exceeds the sink computing device storage capacity. For example, in the case of Transmission Control Protocol (TCP) transport used for direct streaming, if the amount of pre-transmitted data exceeds the buffer on the sink computing device, TCP reads may be stopped at the sink computing device and the buffer cannot be read from the network socket resulting in deadlock at the sink computing device. In case of User Datagram Protocol (UDP) transport used for direct streaming, data may be dropped that exceeds the buffer resulting in a glitchy user experience. Not sending more data than the sink computing device buffer can store may thereby avoids deadlock and/or unwanted drops. Upon storing the transport packet in the buffer, the source computing device may receive another compressed access unit of the media stream in block 302 of the method 300 as described.

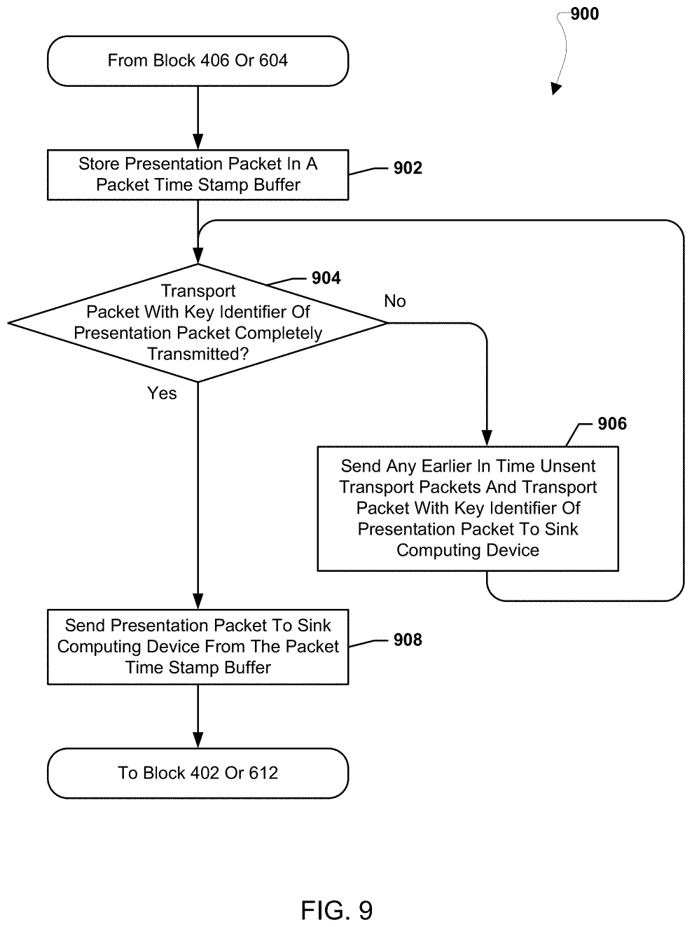

FIG. 9 illustrates a method 900 for sending a presentation packet to a sink computing device according to some embodiments. With reference to FIGS. 1A-9, the method 900 may be performed by a processor of a source computing device, such as a processor of the source computing device 148. In some embodiments, the operations of the method 900 may be performed in conjunction with the operations of the methods 200, 300, 400, 500, 600, 610, 700, 710, and/or 900. In some embodiments, the operations of the method 900 may be performed in response to generating a presentation packet in block 406 of the method 400 or block 604 of the methods 600 or 610 as described.

In block 902, the processor of the source computing device may store the presentation packet in a packet time stamp buffer. The packet time stamp buffer may be a presentation packet buffer (e.g., a PES-packet-queue, a video-PES-packet-queue, etc.) that may be a FIFO queue storing presentation packets for transmission to the sink computing device. In some embodiments, the size of the packet time stamp buffer may be one presentation packet. In this manner, presentation packet transport may initiate as soon as a presentation packet is created and stored in the packet time stamp buffer as one packet may fill the buffer.

In determination block 904, the processor of the source computing device may determine whether a transport packet with a key identifier of the presentation packet is completely transmitted. For example, the processor of the source computing device may determine whether a buffer storing transport packets includes any transport packets associated with the key identifier of the presentation packet. A transport packet in the buffer having a key identifier matching the key identifier indicated in the presentation packet may indicate that transport packet with the key identifier of the presentation packet is not yet completely transmitted to the sink computing device. No transport packet in the buffer having a key identifier matching the key identifier indicated in the presentation packet may indicate the transport packet for that key identifier was already transmitted to the sink computing device. The check of the buffer storing transport packets when a presentation packet is stored in the packet time stamp buffer may ensure the transmission of presentation packets for already transmitted transport packets is prioritized over sending newer transport packets. If there are elements to transmit from both queues, then any elements in the transport packet buffer (e.g., the pre-transmit-queue) associated with the head (oldest) elements in the packet time stamp buffer (e.g., the video keyed-PES-packet-queue), need to be transmitted immediately. If there are no such elements, this means that the access-unit associated with the head element of the packet time stamp buffer (e.g., the video keyed-PES-packet-queue) was already transmitted. Accordingly, the head element of the packet time stamp buffer (e.g., the video keyed-PES-packet-queue) needs to be transmitted. If there are elements in the transport packet buffer (e.g., the pre-transmit-queue) but none in the packet time stamp buffer (e.g., the video keyed-PES-packet-queue), then the priority scheme for transport packet transmission may be applied, such as the operations of the method 800 as described.

In response to determining that a transport packet with a key identifier of the presentation packet is not completely transmitted (i.e., determination block 904=“No”), the processor of the source computing device may send any earlier in time unsent transport packets and the transport packet with the key identifier of the presentation packet to the sink computing device in block 906. In this manner, should there be elements to transmit from both the transport packet buffer (e.g., the pre-transmit-queue) and the packet time stamp buffer (e.g., the video keyed-PES-packet-queue), any elements in the transport packet buffer (e.g., the pre-transmit-queue) earlier in time or associated with the presentation packet in the packet time stamp buffer (e.g., the video keyed-PES-packet-queue) may be transmitted immediately. Upon sending the transport packets in block 906, the processor of the source computing device may determine whether a transport packet with a key identifier of the presentation packet is completely transmitted in determination block 904.

In response to determining that a transport packet with a key identifier of the presentation packet is completely transmitted (i.e., determination block 904=“Yes”), the processor of the source computing device may send the presentation packet to the sink computing device from the packet time stamp buffer in block 908. Upon sending the presentation packet, the source computing device may again determine whether a compressed access unit of the media stream was processed by the media player in determination block 402 of the method 400 as described with reference to FIG. 4, or may determine whether the sink computing device is access unit drop capable in determination block 612 of the method 610 as described with reference to FIG. 6B.

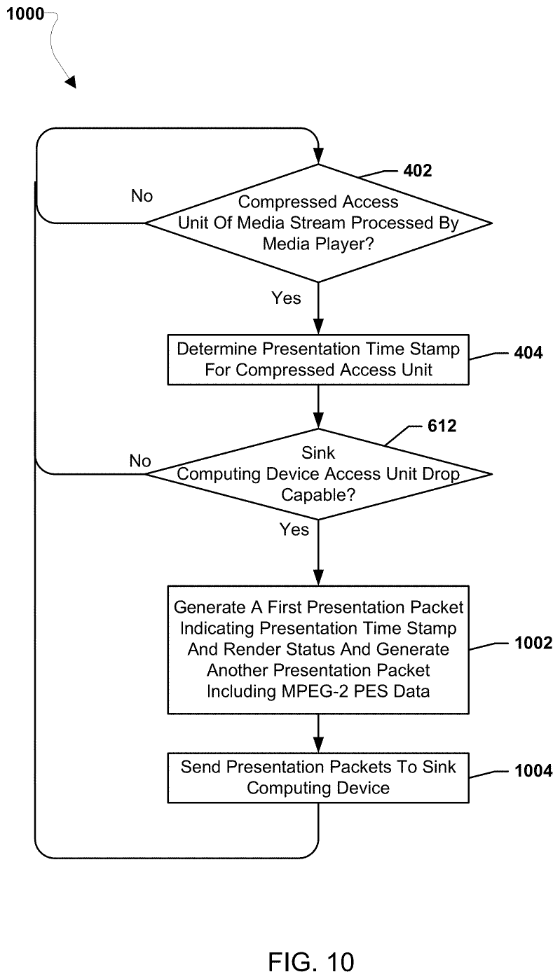

FIG. 10 illustrates a method 1000 for streaming a compressed media stream according to some embodiments. With reference to FIGS. 1A-10, the method 1000 may be performed by a processor of a source computing device, such as a processor of the source computing device 148. In some embodiments, the operations of the method 1000 may be performed in conjunction with the operations of the method 200. In some embodiments, the operations of method 1000 may be performed in response to the source computing device starting direct streaming of a media stream.

In blocks 402 and 404, the processor of the source computing device may perform operations of like numbered blocks of the method 400 described with reference to FIG. 4. In determination block 612, the processor of the source computing device may perform operations of the like numbered block of the method 610 described with reference to FIG. 6B.

In block 1002, the processor of the source computing device may generate a first presentation packet indicating the presentation time stamp and the render status and may generate another presentation packet including MPEG2-PES packet data. For example, the first presentation packet may be sent over MPEG private-stream-2. As an example, the other presentation packet including MPEG2-PES packet data may itself be an MPEG2-PES packet. In some embodiments, the first presentation packet may indicate the presentation time stamp for the compressed access unit and the render status of the compressed access unit. The render status may be an indication of whether the media player rendered the access unit decoded from the compressed access unit or dropped the access unit decoded from the compressed access unit. In some embodiments, the render status may be indicated by a flag setting in the access unit's metadata in the first presentation packet. For example, a “decode-only” flag may be set when the access unit was dropped by the media player.

In block 1004, the processor of the source computing device may send the presentation packets to the sink computing device. Sending the presentation packets may include directly sending the presentation packet to the sink computing device and/or buffering the presentation packet, such as in a video-PES-packet-queue, prior to transmission to the sink computing device. The presentation packet may be sent over a Wi-Fi type connection to the sink computing device, such as Wi-Fi Miracast® connection, Apple AirPlay® connection, Wi-Di connection, etc. For example, the presentation packets may be sent in an MPEG-2 is private stream 2.

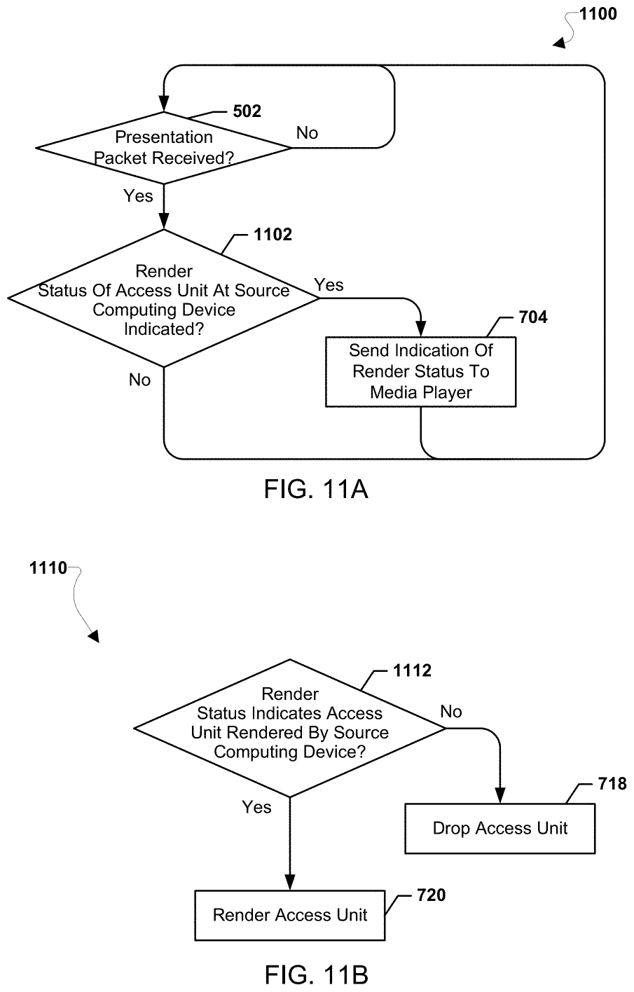

FIG. 11A illustrates a method 1100 for streaming a compressed media stream according to some embodiments. With reference to FIGS. 1A-11A, the method 1100 may be performed by a processor of a sink computing device, such as a processor of the sink computing device 149. In some embodiments, the operations of the method 1100 may be performed in conjunction with the operations of the methods 200 and/or 1000.

In block 502, the processor of the sink computing device may perform operations of the like numbered block of the method 500 described with reference to FIG. 5.

In determination block 1102, the processor of the sink computing device may determine whether the render status of the access unit at the source computing device is indicated. Access units may be dropped by source computing devices for various reasons, including pausing occurring, fast forwarding occurring, rewinding occurring, or any other reason. The render status may be an indication of whether the media player at the source computing device rendered the access unit decoded from the compressed access unit or dropped the access unit decoded from the compressed access unit. Render statuses may be indicated in presentation packets received by the sink computing device from the source computing device. The presence of a data element associated with a render action in the presentation packet may indicate whether or not the render status of the compressed access unit is indicated. A data element associated with a render action may indicate the render status is indicated and the lack of a data element associated with a render action may indicate the render status is not indicated. Render statuses may be received in presentation packets including the presentation time stamp for the compressed access unit and/or may be received in presentation packets sent separately from those indicating the presentation time stamp.

In response to determining that the render status of the access unit at the source computing device is not indicated (i.e., determination block 1102=“No”), the processor of the sink computing device may determine whether a presentation packet is received in block 502 as described for the like numbered block of the method 500 with reference to FIG. 5.

In response to determining that the render status of the access unit is indicated (i.e., determination block 1102=“Yes”), the processor of the sink computing device may send an indication of the render status to the media player in block 704 as described for the like numbered block of the method 700 with reference to FIG. 7A.

FIG. 11B illustrates a method 1110 for streaming a compressed media stream according to some embodiments. With reference to FIGS. 1A-11B, the method 1110 may be performed by a processor of a sink computing device, such as a processor of the sink computing device 149. As a specific example, the operations of method 1110 may be performed by a component of the media player running on a processor of a sink computing device, such as media player component 170 of sink computing device 149. In some embodiments, the operations of the method 1110 may be performed in conjunction with the operations of the methods 200, 1000, and/or 1100. In some embodiments, the operations of method 1110 may be performed after receiving an access unit from a source computing device.

In determination block 1112, the processor of the sink computing device may determine whether the render status indicates that the access unit was rendered by the source computing device. Access units may be dropped by source computing devices for various reasons, including pausing occurring, fast forwarding occurring, rewinding occurring, or any other reason. The render status may be an indication of whether the media player at the source computing device rendered the access unit decoded from a compressed access unit or dropped the access unit decoded from a compressed access unit. An indication of the render status may have been sent to the media player from a transport component (e.g., transport component 162) of the sink computing device. For example, the indication of the render status may be an indication that the media player at the source computing device rendered the access unit or an indication that the media player at the source computing device dropped the access unit. The indication of the render status may have been sent to the media player as a separate message to the media player and/or may have been sent with the compressed access unit and/or presentation time stamps.

In response to determining that the access unit was not rendered by the source computing device (i.e., determination block 1112=“No”), the processor of the sink computing device may drop the decoded access unit in block 718 as described for the like numbered block of the method 710 with reference to FIG. 7B. In response to determining that the access unit was rendered by the source computing device (i.e., determination block 1112=“Yes”), the processor of the sink computing device may render the access unit in block 720 as described for the like numbered block of the method 710 with reference to FIG. 7B.

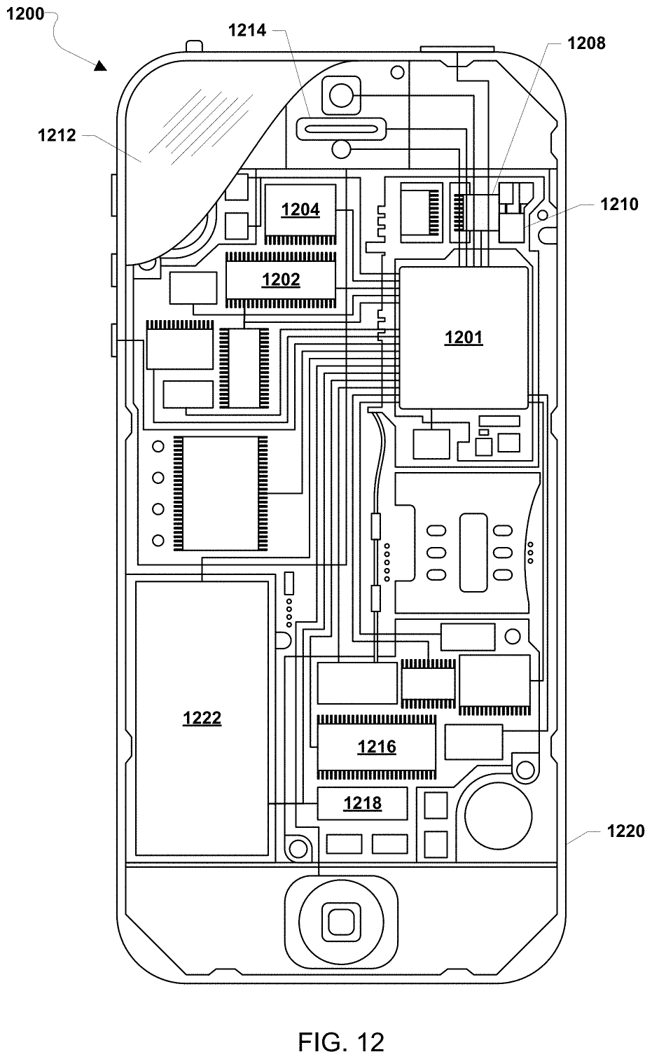

The various embodiments may be implemented in a variety of computing devices, an example of which in the form of a mobile device 1200 is illustrated in FIG. 12. With reference to FIGS. 1A-12, the mobile device 1200 may include a processor 1201 coupled to a touch screen controller 1204 and an internal memory 1202. The processor 1201 may be one or more multi-core integrated circuits (ICs) designated for general or specific processing tasks. The internal memory 1202 may be volatile or non-volatile memory, and may also be secure and/or encrypted memory, or unsecure and/or unencrypted memory, or any combination thereof The touch screen controller 1204 and the processor 1201 may also be coupled to a touch screen panel 1212, such as a resistive-sensing touch screen, capacitive-sensing touch screen, infrared sensing touch screen, etc.

The mobile device 1200 may have one or more radio signal transceivers 1208 (e.g., Bluetooth®, ZigBee®, Wi-Fi®, radio frequency (RF) radio) and antennae 1210, for sending and receiving, coupled to each other and/or to the processor 1201. The transceivers 1208 and antennae 1210 may be used with the above-mentioned circuitry to implement the various wireless transmission protocol stacks and interfaces. In some embodiments, the mobile device 1200 may include a cellular network wireless modem chip 1216 that enables communication via a cellular network and is coupled to the processor.

The mobile device 1200 may include a peripheral device connection interface 1218 coupled to the processor 1201. The peripheral device connection interface 1218 may be singularly configured to accept one type of connection, or multiply configured to accept various types of physical and communication connections, common or proprietary, such as universal serial bus (USB), FireWire, Thunderbolt, or PCIe. The peripheral device connection interface 1218 may also be coupled to a similarly configured peripheral device connection port (not shown).

The mobile device 1200 may also include speakers 1214 for providing audio outputs. The mobile device 1200 may also include a housing 1220, constructed of a plastic, metal, or a combination of materials, for containing all or some of the components discussed herein. The mobile device 1200 may include a power source 1222 coupled to the processor 1201, such as a disposable or rechargeable battery. The rechargeable battery may also be coupled to the peripheral device connection port to receive a charging current from a source external to the mobile device 1200.

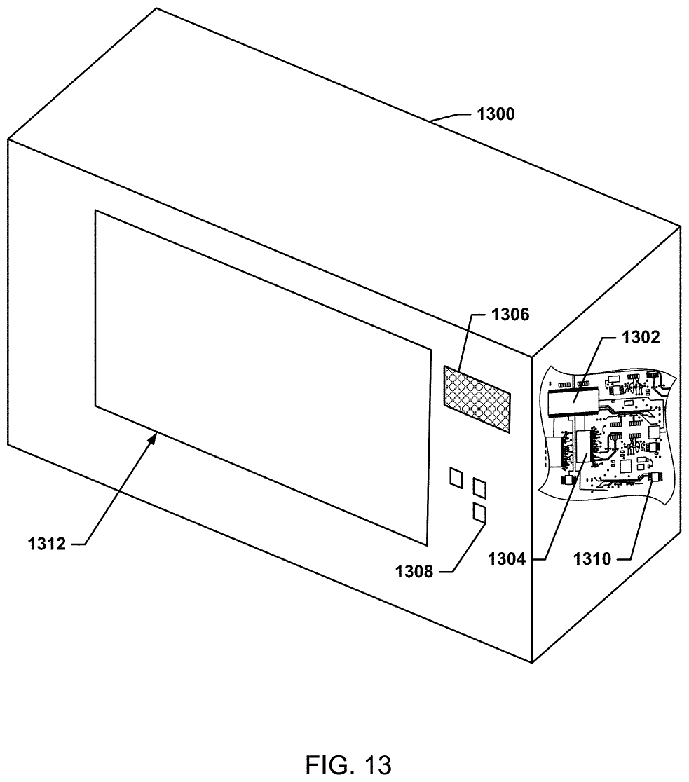

The various embodiments described above may also be implemented within a variety of computing devices, such as display unit 1300 illustrated in FIG. 13.

With reference to FIGS. 1A-13, a display unit 1300 may include a processor 1302 coupled to a memory 1304. The display unit 1300 may include a speaker 1306 that may be connected to the processor and configured to output sound. The display unit 1300 may also include one or more radio signal transceivers 1310 (e.g., Bluetooth®, ZigBee®, Wi-Fi®, RF radio, etc.) and antennae, for sending and receiving, coupled to each other and/or to the processor 1302. The transceivers 1310 and antennae may be used with the above-mentioned circuitry to implement the various wireless transmission protocol stacks and interfaces). The display unit 1300 may also include a touchpad 1308 and screen 1312 all coupled to the processor 1302.

The processor (e.g., 1201, 1302) may be any programmable microprocessor, microcomputer or multiple processor chip or chips that can be configured by software instructions (applications) to perform a variety of functions, including the functions of various embodiments as described. In some devices, multiple processors may be provided, such as one processor dedicated to wireless communication functions and one processor dedicated to running other applications. Typically, software applications may be stored in the internal memory before they the software applications are accessed and loaded into the processor (e.g., 1201, 1302). The processor (e.g., 1201, 1302) may include internal memory sufficient to store the application software instructions. In many devices, the internal memory may be a volatile or nonvolatile memory, such as flash memory, or a mixture of both. For the purposes of this description, a general reference to memory refers to memory accessible by the processor (e.g., 1201, 1302), including internal memory or removable memory plugged into the device and memory within the processor (e.g., 1201, 1302) itself.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, components, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of various embodiments.

The hardware used to implement the various illustrative logics, logical blocks, components, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, various embodiments are not intended to be limited to the embodiments shown herein but are to be accorded the widest scope consistent with the following claims and the principles and novel features disclosed herein.

What is claimed is:

1. A sink computing device, comprising:
a processor configured to:
receive a presentation packet from a source computing device, wherein the presentation packet indicates a render status render status and a presentation time stamp assigned by the source computing device to an access unit of a media stream;
determine whether the render status indicates the access unit was rendered by the source computing device;
drop the access unit in response to determining that the render status indicates the access unit was not rendered by the source computing device; and
render the access unit in response to determining that the render status indicates the access unit was rendered by the source computing device.

2. The sink computing device of claim 1, wherein the processor is further configured to:
receive a get message from the source computing device, the get message requesting parameters from the sink computing device; and
send an indication of access unit drop capability to the source computing device in response to receiving the get message.

3. The sink computing device of claim 1, wherein the media stream is a video stream or audio stream.

4. The sink computing device of claim 1, wherein the source computing device and the sink computing device are operating in Wi-Fi Miracast® direct mode.

5. A method of rendering a compressed media stream, comprising:
receiving, in a processor of a sink computing device, a presentation packet from a source computing device, wherein the presentation packet indicates a render status render status and a presentation time stamp assigned by the source computing device to an access unit of a media stream;
determining, by the processor of the sink computing device, whether the render status indicates the access unit was rendered by the source computing device;
dropping, by the processor of the sink computing device, the access unit in response to determining that the render status indicates the access unit was not rendered by the source computing device; and
rendering, by the processor of the sink computing device, the access unit in response to determining that the render status indicates the access unit was rendered by the source computing device.

6. The method of claim 5, further comprising:
receiving, by the processor of the sink computing device, a get message from the source computing device, the get message requesting parameters from the sink computing device; and
sending, by the processor of the sink computing device, an indication of access unit drop capability to the source computing device in response to receiving the get message.

7. The method of claim 5, wherein the media stream is a video stream or audio stream.

8. The method of claim 5, wherein the source computing device and the sink computing device are operating in Wi-Fi Miracast® direct mode.

9. A source computing device, comprising:
a processor configured to:
determine a presentation time stamp for a compressed access unit of a media stream;
determine a render status for the compressed access unit;
generate a presentation packet indicating the render status and the presentation time stamp; and
send the presentation packet to a sink computing device.

10. The source computing device of claim 9, wherein the media stream is a video stream or an audio stream.

11. The source computing device of claim 10, wherein the source computing device and the sink computing device are operating in Wi-Fi Miracast® direct mode.

12. A method of streaming a compressed media stream, comprising:
determining, by a processor of a source computing device, a presentation time stamp for a compressed access unit of a media stream;
determining, by the processor of the source computing device, a render status for the compressed access unit;
generating, by the processor of the source computing device, a presentation packet indicating the render status and the presentation time stamp; and
sending, by the processor of the source computing device, the presentation packet to a sink computing device.

13. The method of claim 12, wherein the media stream is a video stream or an audio stream.

14. The method of claim 13, wherein the source computing device and the sink computing device are operating in Wi-Fi Miracast® direct mode.
